(19) United States
(12) Patent Application Publication
(10) Pub. No.: US 2026/0139614 A1
(43) Pub. Date: May 21, 2026

(54) DETACHABLE AND LUBRICABLE PACKING GLAND FOR ELECTRIC LARGE-CALIBER BUTTERFLY VALVE

(71) Applicant: HUANENG QINBEI POWER GENERATION CO., LTD., Jiyuan (CN)

(72) Inventors: Jiangchuan GUO, Jiyuan (CN); Yuejun FAN, Jiyuan (CN); Shuangxi SONG, Jiyuan (CN); Huipeng FAN, Jiyuan (CN); Libing YANG, Jiyuan (CN); Jianping ZHANG, Jiyuan (CN); Jie LIU, Jiyuan (CN); Yang YU, Jiyuan (CN); Yonglin QU, Jiyuan (CN); Xu GAO, Jiyuan (CN)

(73) Assignee: HUANENG QINBEI POWER GENERATION CO., LTD., Jiyuan (CN)

(21) Appl. No.: 19/437,509

(22) Filed: Dec. 31, 2025

Related U.S. Application Data
(63) Continuation of application No. PCT/CN2025/118111, filed on Aug. 30, 2025.

(30) Foreign Application Priority Data
Nov. 20, 2024 (CN) 2024116662852

(51) Int. Cl. F01M 9/10; F16K 41/02

(52) U.S. Cl. CPC F01M 9/103; F16K 41/026

(57) ABSTRACT

A detachable and lubricable packing gland for an electric large caliber butterfly valve is provided, including a packing gland body; the packing gland body includes a gland body and a pressure ring, a mounting groove is provided on the bottom of the gland body, and a first sealing ring is arranged; a first through hole for a valve stem to pass through is provided, and the first through hole is connected to communicate with the mounting groove; a second through hole for the valve stem to pass through is provided, and a lubrication groove is provided on a hole wall of the second through hole; an oiling hole is provided on the pressure ring, a chip removal hole is provided on the other side, and both are connected to the lubrication groove. The present disclosure is simple and fast in maintenance and disassembly and ensures smooth production.

### CROSS-REFERENCE TO RELATED APPLICATIONS

The application claims priority to Chinese patent application No. 2024116662852, filed on Nov. 20, 2024, the entire contents of which are incorporated herein by reference.

### TECHNICAL FIELD

The present disclosure relates to a detachable and lubricable packing gland for an electric large caliber butterfly valve, belonging to the technical field of valve sealing structures.

### BACKGROUND

The large-caliber butterfly valve for circulating water is a butterfly valve with a generally oversized nominal diameter and a bigger valve stem size. At present, the common packing glands for large-caliber butterfly valves are mostly designed with one-piece welding, made of cast iron or cast steel, and their own lubrication ability is almost zero.

For example, a utility model patent with Chinese Patent Authorization Announcement No. CN202431987U discloses a large-caliber butterfly valve whose parts can be disassembled and replaced immediately. The disclosed sealing gland is an integral welded structure. When this type of large-caliber butterfly valve is in use, due to the large contact area and small gap between the gland and the valve stem, rust often gets stuck in the gap between the gland and the valve stem. Even though this large-caliber butterfly valve has a diamond oil groove at the sleeve position for lubricating the valve stem to reduce the tightening force on the valve stem when it rotates at the gland position, since the gland position is not lubricated, the rust stuck in the gap between the gland and the valve stem will cause the gland and the valve stem to lock. Once the gland and the valve stem are locked, the radial clearance of the gland will often be too small and the tightening force will be too large when the butterfly valve is opened and closed, which can easily cause damage to the thrust bearings in external reduction mechanisms such as worm gears, thereby worsening early abnormal wear of external reduction mechanisms such as worm gears, causing great trouble and serious impact on production.

### SUMMARY

### Technical Problems

Since the sealing gland is an integrated welded structure, when the gland and the valve stem are locked and need to be disassembled and repaired on site, it is necessary to dismantle the external actuator of the butterfly valve before the sealing gland can be disassembled, which has the problem of large maintenance and disassembly workload.

### Technical Solutions

In order to solve the preceding problems existing in the prior art, the present disclosure provides a detachable and lubricable packing gland for an electric large caliber butterfly valve.

The technical solution of the present disclosure is as follows:

A detachable and lubricable packing gland for an electric large caliber butterfly valve is provided, including a packing gland body; the packing gland body includes a gland body and a pressure ring, the pressure ring is arranged at the bottom of the gland body, a mounting groove is provided on the bottom of the gland body, the diameter of the mounting groove is larger than the outer diameter of the pressure ring, the top of the pressure ring is arranged to extend into the mounting groove, and a first sealing ring is arranged in a gap between the mounting groove and an outer wall of the top of the pressure ring; a first through hole for a valve stem to pass through is provided on the gland body, and the first through hole is connected to communicate with the mounting groove; a second through hole for the valve stem to pass through is provided on the pressure ring, and a lubrication groove is provided on a hole wall of the second through hole; the lubrication groove is provided at a middle position of the hole wall of the second through hole; an oiling hole is provided on an outer wall of one side of the pressure ring, a chip removal hole is provided on an outer wall of the other side, and both the oiling hole and the chip removal hole are connected to communicate with the lubrication groove.

Furthermore, a mounting bracket is further arranged below the gland body, the mounting bracket is arranged in a T-shaped structure, a mounting hole is provided on the mounting bracket, the gland body is placed on the top surface of the mounting bracket, and the pressure ring is arranged to extend into the mounting hole; an inlet hole is provided on an outer wall of one side of the mounting bracket, and the inlet hole is connected to communicate with the oiling hole; an outlet hole is provided on an outer wall of the other side of the mounting bracket, and the outlet hole is connected to communicate with the chip removal hole; and an adjusting assembly is further provided on the bottom wall of a top cross section structure of the mounting bracket close to the inlet hole.

Furthermore, the adjusting assembly includes an adjusting box, and a fixing groove is provided on the bottom wall of the top cross section structure of the mounting bracket; the adjusting box is fixedly mounted in the fixing groove, the bottom of the adjusting box extends outward from the fixing groove, and an oiling nozzle and a one-way valve are arranged on the box body where the adjusting box extends out of the fixing groove; the oiling nozzle is arranged on the side wall of the adjusting box away from the inlet hole, the one-way valve is arranged on the side wall of the adjusting box close to the inlet hole, and the one-way valve is arranged extending into the inlet hole; an adjusting cavity is provided inside the adjusting box, connecting holes are symmetrically arranged inside the adjusting cavity, and the connecting holes on both sides are respectively connected to communicate with the oiling nozzle and the one-way valve; a piston is further movably provided inside the adjusting cavity, the piston moves along the adjusting cavity to control the conduction state of the connecting holes on both sides, the piston is connected to the top wall of the adjusting cavity by providing a first spring, and a piston rod is further provided on the piston.

Furthermore, a first mounting threaded hole and multiple first mounting bolt holes are provided on the top cross section structure of the mounting bracket, among them, the first mounting threaded hole is connected to communicate with the fixing groove, and an end of the piston rod away from the piston side is movably extended from the top of the adjusting box into the first mounting threaded hole; a second mounting threaded hole and multiple second mounting bolt holes are provided on the gland body, the second mounting threaded hole is arranged corresponding to the first mounting threaded hole, and the second mounting bolt holes are arranged in a one-to-one correspondence with the first mounting bolt holes.

Furthermore, a second sealing ring is arranged in the inlet hole, and the one-way valve is arranged to pass through the second sealing ring after entering the inlet hole.

Furthermore, the valve stem passes through the gland body and the pressure ring in sequence and then enters the mounting hole, a packing filler is filled between the hole wall of the mounting hole and the outer wall of the valve stem, and the bottom wall of the pressure ring is pressed against the packing filler.

Furthermore, an adjusting groove is further provided on the bottom of the gland body, the adjusting groove is connected to communicate with the mounting groove, a second spring is arranged in the adjusting groove, and an end of the second spring close to the pressure ring side is pressed against the pressure ring; and when the bottom wall of the pressure ring is pressed against the packing, the second spring is in a compressed state.

Furthermore, an adjusting pressure plate is movably arranged in the adjusting groove, and the bottom surface of the adjusting pressure plate is connected to an end of the second spring away from the pressure ring side; multiple adjusting threaded holes are provided on the top of the gland body, each adjusting threaded hole is connected to communicate with the adjusting groove, each adjusting threaded hole is threadedly connected with an adjusting screw, and the bottom of each adjusting screw is connected to the adjusting pressure plate.

Furthermore, an aperture of the oiling hole is set larger than that of the inlet hole, and the aperture setting of the oiling hole satisfies that when the pressure ring moves in the mounting hole under the action of the second spring and the adjusting pressure plate, the oiling hole can be connected to communicate with the inlet hole at any time; and an aperture of the chip removal hole is set larger than that of the outlet hole, and the aperture setting of the chip removal hole satisfies that when the pressure ring moves in the mounting hole under the action of the second spring and the adjusting pressure plate, the chip removal hole can be connected to communicate with the outlet hole at any time.

Furthermore, a pressure sensor is further embedded on the bottom wall of the pressure ring, and the detection end of the pressure sensor is tightly arranged against the packing filler.

### Beneficial Effects

The present disclosure provides a mounting groove at the bottom of a gland body and with the cooperative setting of a first sealing ring, a pressure ring and the gland body are connected so as to set the packing gland body as a split structure. When maintenance work is required, the specific condition of the valve stem can be checked by simply removing the gland body from the mounting bracket. In most cases, it is not necessary to remove the connecting pressure ring together, so there is no need to disassemble the actuator outside the butterfly valve. The workload of maintenance and disassembly is greatly reduced. Moreover, by setting a lubrication groove on the pressure ring, and with the cooperative setting of an oiling hole and a chip removal hole, lubricating oil is injected into the oiling hole, and the lubricating oil enters the lubrication groove. The lubrication groove provides a receiving position for the lubricating oil, and can also reduce the contact area between the pressure ring and the valve stem. This not only makes the valve stem rotate more smoothly, but also brings out the rust that entered between the valve stem and the pressure ring from the chip removal hole. Thus, the valve stem can be prevented from locking as much as possible, thereby reducing the subsequent abnormal wear of the external reduction mechanism. Compared with the prior art, it has the advantages of simple and fast maintenance and disassembly, not prone to locking, and ensuring smooth production.

### BRIEF DESCRIPTION OF DRAWINGS

FIG. 1 is a structural diagram of the present disclosure;

FIG. 2 is a top view of a gland body in the present disclosure;

FIG. 3 is an enlarged view at A; and

FIG. 4 is an enlarged view at B.

The reference numerals in the drawing are as follows:

1. packing gland body; 2. gland body; 3. pressure ring; 4. mounting groove; 5. first sealing ring; 6. valve stem; 7. first through hole; 8. second through hole; 9. lubrication groove; 10. oiling hole; 11. chip removal hole; 12. mounting bracket; 13. mounting hole; 14. inlet hole; 15. outlet hole; 16. adjusting box; 17. fixing groove; 18. oiling nozzle; 19. one-way valve; 20. adjusting cavity; 21. connecting hole; 22. piston; 23. first spring; 24. piston rod; 25. first mounting threaded hole; 26. first mounting bolt hole; 27. second mounting threaded hole; 28. second mounting bolt hole; 29. second sealing ring; 30. packing filler; 31. adjusting groove; 32. second spring; 33. adjusting pressure plate; 34. adjusting threaded hole; 35. adjusting screw; and 36. pressure sensor.

### DETAILED DESCRIPTION OF THE EMBODIMENTS

The present disclosure is described in detail below with reference to the accompanying drawings and specific embodiments.

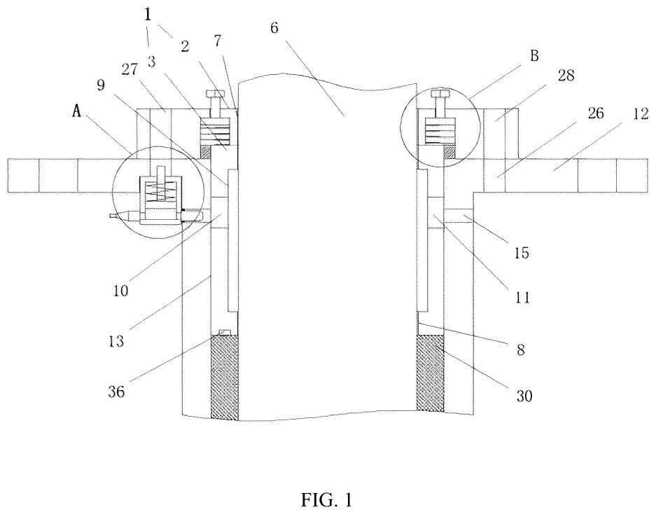

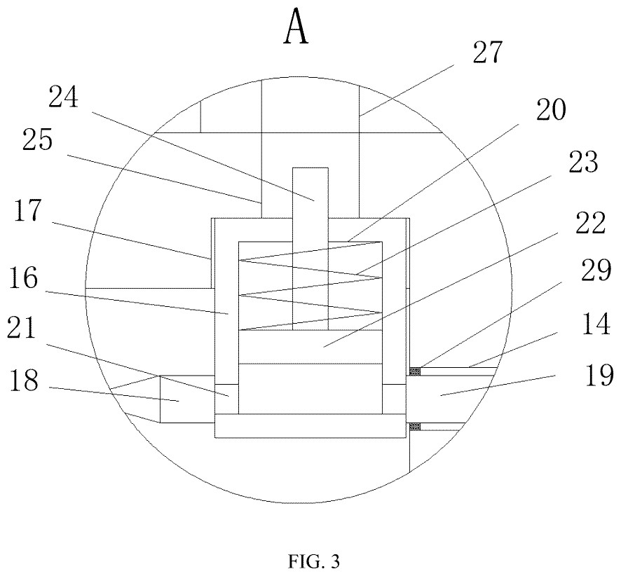

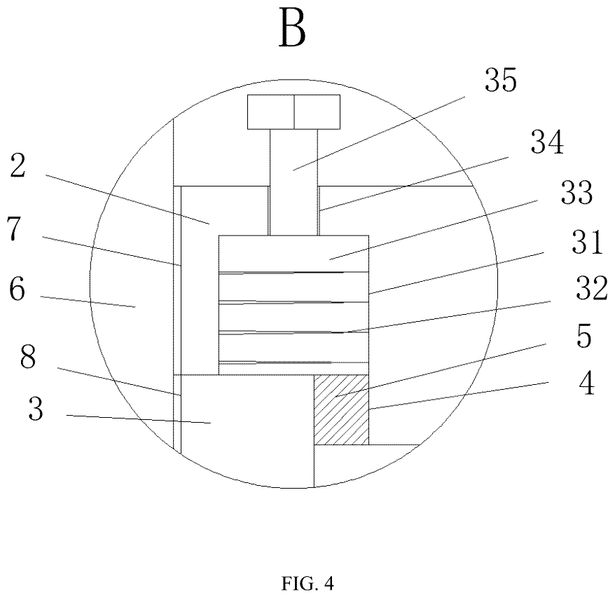

Embodiment 1: As shown in FIGS. 1, 3, and 4. This embodiment provides a detachable and lubricable packing gland for an electric large caliber butterfly valve, including a packing gland body 1. The packing gland body 1 includes a gland body 2 and a pressure ring 3. The pressure ring 3 is arranged at the bottom of the gland body 2. A mounting groove 4 arranged in an annular structure is provided on the bottom of the gland body 2. The mounting groove 4 is coaxially arranged with the gland body 2. The diameter of the mounting groove 4 is larger than the outer diameter of the pressure ring 3. The specific diameter value of the mounting groove 4 can be determined according to actual conditions. The top of the pressure ring 3 is arranged to extend into the mounting groove 4, and a first sealing ring 5 is arranged in a gap between the mounting groove 4 and an outer wall of the top of the pressure ring 3. Both the pressure ring 3 and the first sealing ring 5 are coaxially arranged with the mounting groove 4. An outer wall of the first sealing ring 5 can be pressed against a side groove wall of the mounting groove 4, and an inner wall of the first sealing ring 5 can be pressed against the outer wall of the top of the pressure ring 3. The pressure ring 3 can be connected to the gland body 2 through the friction force generated by the first sealing ring 5.

Through the preceding arrangement, by setting the packing gland body 1 as a split structure, that is, the gland body 2 and the pressure ring 3 can be disassembled, when maintenance is required, only the gland body 2 needs to be removed to perform corresponding maintenance. In most cases, it is not necessary to take out the communicating pressure ring 3 together. Therefore, there is no need to disassemble the actuator outside the butterfly valve, which greatly reduces the maintenance and disassembly workload.

A first through hole 7 for a valve stem 6 to pass through is provided on the gland body 2, the first through hole 7 is connected to communicate with the mounting groove 4, and the first through hole 7 is further coaxially arranged with the mounting groove 4. A second through hole 8 for the valve stem 6 to pass through is provided on the pressure ring 3, an aperture of the second through hole 8 is the same as that of the first through hole 7, and the second through hole 8 is coaxially arranged with the first through hole 7. A lubrication groove 9 is provided on a hole wall of the second through hole 8, and the lubrication groove 9 is further arranged in an annular structure. The lubrication groove 9 is provided at a middle position of the hole wall of the second through hole 8. The diameter of the lubrication groove 9 can be determined according to actual conditions, but it should not be too large to avoid excessive lubricating oil entering the lubrication groove 9 later, which may cause the valve stem 6 to slip. In this embodiment, the diameter of the lubrication groove 9 being 0.8 to 1 mm larger than the aperture of the second through hole 8 is suitable. An oiling hole 10 is provided on an outer wall of one side of the pressure ring 3, a chip removal hole 11 is provided on an outer wall of the other side, and both the oiling hole 10 and the chip removal hole 11 are connected to communicate with the lubrication groove 9. The oiling hole 10 and the chip removal hole 11 are set at the same horizontal height, and the oiling hole 10 and the chip removal hole 11 are both set at an upper position in the middle of the pressure ring 3, so that the residence time of the lubricating oil subsequently entering the lubrication groove 9 can be extended, thereby improving the lubrication effect.

Through the preceding setting, the lubrication groove 9 can not only provide a storage space for lubricating oil, but also reduce the contact area between the pressure ring 3 and the valve stem 6. During operation, by injecting lubricating oil from the outside into the oiling hole 10, the lubricating oil enters the lubrication groove 9 so that it can be distributed on the valve stem 6, thereby reducing the resistance generated when the valve stem 6 rotates, making the valve stem 6 rotate more smoothly. Moreover, the lubricating oil entering the lubrication groove 9 can further bring out the rust entering between the valve stem 6 and the pressure ring 3 from the chip removal hole 11. Thus, the locking phenomenon of the valve stem 6 can be avoided as much as possible, and the subsequent abnormal wear of the external reduction mechanism can be reduced.

In this embodiment, a mounting bracket 12 is further provided below the gland body 2, and the mounting bracket 12 is configured for subsequent mounting of the butterfly valve body. The mounting bracket 12 is arranged in a T-shaped structure, a mounting hole 13 is provided on the mounting bracket 12, the gland body 2 is placed on the top surface of the mounting bracket 12, the pressure ring 3 is arranged to extend into the mounting hole 13, and the pressure ring 3 is coaxially arranged with the mounting hole 13; the valve stem 6 passes through the gland body 2 and the pressure ring 3 in sequence and then enters the mounting hole 13, a packing filler 30 is filled between the hole wall of the mounting hole 13 and the outer wall of the valve stem 6, and the bottom wall of the pressure ring 3 is pressed against the packing filler 30. An inlet hole 14 is provided on an outer wall of one side of the mounting bracket 12, and the inlet hole 14 is connected to the oiling hole 10, and an outlet hole 15 is provided on an outer wall of the other side of the mounting bracket 12, and the outlet hole 15 is connected to communicate with the chip removal hole 11. By injecting lubricating oil into the inlet hole 14, the lubricating oil can enter the lubrication groove 9 through the oiling hole 10, and the waste oil and rust discharged from the chip removal hole 11 can be discharged outward from the outlet hole 15 for corresponding collection.

In order to be able to regulate the amount of lubricating oil intake, and ensure the reliability of the valve stem 6 during operation, in this embodiment, an adjusting assembly 12 is further provided on the bottom wall of a top cross section structure of the mounting bracket close to the inlet hole 14. The adjusting assembly includes an adjusting box 16, and a fixing groove 17 is provided on the bottom wall of the top cross section structure of the mounting bracket 12. The adjusting box 16 is fixedly installed in the fixing groove 17. The bottom of the adjusting box 16 extends outward from the fixing groove 17. An oiling nozzle 18 and a one-way valve 19 are arranged on the box body where the adjusting box 16 extends out of the fixing groove 17. The oiling nozzle 18 is arranged on the side wall of the adjusting box 16 away from the inlet hole 14. The oiling nozzle 18 is configured to connect with an external component for conveying lubricating oil, and the one-way valve 19 is arranged on the side wall of the adjusting box 16 close to the inlet hole 14, and the one-way valve 19 is arranged extending into the inlet hole 14. The conduction direction of the one-way valve 19 is from the adjusting box 16 to the inlet hole 14. An adjusting cavity 20 is provided inside the adjusting box 16, and connecting holes 21 are symmetrically arranged inside the adjusting cavity 20. The connecting holes 21 on both sides are respectively connected to communicate with the oiling nozzle 18 and the one-way valve 19, so that the lubricating oil entering from the oiling nozzle 18 can enter the one-way valve 19 after passing through the adjusting cavity 20 under the conveying action of the connecting holes 21 on both sides. A piston 22 is further movably provided inside the adjusting cavity 20, the piston 22 moves along the adjusting cavity 20 to control the conduction state of the connecting holes 21 on both sides, and the piston 22 is connected to the top wall of the adjusting cavity 20 by providing a first spring 23, that is, two ends of the first spring 23 are fixedly connected to the top surface of the piston 22 and the top wall of the adjusting cavity 20, respectively. A piston rod 24 arranged vertically upward is further fixedly provided on the top surface of the piston 22. A first mounting threaded hole 25 and multiple first mounting bolt holes 26 are provided on the top cross section structure of the mounting bracket 12. In this embodiment, there are three first mounting bolt holes 26, and the first mounting bolt holes 26 and the first mounting threaded hole 25 are distributed in an array centered on the centerline of the mounting bracket 12. Among them, the first mounting threaded hole 25 is connected to communicate with the fixing groove 17, and an end of the piston rod 24 away from the piston 22 side is movably extended from the top of the adjusting box 16 into the first mounting threaded hole 25; a second mounting threaded hole 27 and multiple second mounting bolt holes 28 are provided on the gland body 2, the second mounting threaded hole 27 is arranged corresponding to the first mounting threaded hole 25, and the second mounting bolt holes 28 are arranged in a one-to-one correspondence with the first mounting bolt holes 26.

With the preceding arrangement, by threading the corresponding mounting screws into the first mounting threaded hole 25 and the second mounting threaded hole 27, the bottom of the mounting screw will abut against the top of the piston rod 24 after entering the first mounting threaded hole 25 from the second mounting threaded hole 27. As the mounting screw is continuously screwed in, the piston rod 24 will be pushed to drive the piston 22 to move downward. During the downward movement of the piston 22, the connecting holes 21 on both sides in the adjusting cavity 20 will be gradually blocked, thereby reducing the flow rate of the connecting hole 21, and further reducing the flow rate of the lubricating oil flowing out of the one-way valve 19. In this process, the first spring 23 will generate tension. When the flow rate of the connecting hole 21 needs to be increased, the mounting screw is reversed so that the mounting screw moves away from the first mounting threaded hole 25. At this moment, the piston rod 24 will move upward under the reset action of the first spring 23, thereby driving the piston 22 to move upward. During the upward movement of the piston 22, it will gradually expose the connecting holes 21 on both sides in the adjusting cavity 20, thereby increasing the flow rate of the connecting hole 21, and then increasing the flow rate of the lubricating oil flowing out of the one-way valve 19, which can realize the regulation of the amount of lubricating oil intake. The amount of lubricating oil intake can be determined according to actual conditions, such as by observing the oil output of the outlet hole 15 and the discharge of rust, to regulate the amount of lubricating oil intake. Moreover, the arrangement of the first mounting threaded hole 25, the second mounting threaded hole 27, the first mounting bolt holes 26, and the second mounting bolt holes 28 can further enable the gland body 2 to be fixedly connected to the mounting bracket 12 by passing corresponding mounting bolts through the first mounting bolt holes 26 and the second mounting bolt holes 28 and locking the nuts and by threading corresponding mounting screws into the first mounting threaded hole 25 and the second mounting threaded hole 27 when it needs to be mounted on the mounting bracket 12. The oil volume control structure and the connection structure are partially overlapped to reduce the required components and improve the practicality of the packing gland.

In order to ensure the sealing of the connection between the one-way valve 19 and the inlet hole 14, a second sealing ring 29 is arranged in the inlet hole 14, and the one-way valve 19 is arranged to pass through the second sealing ring 29 after entering the inlet hole 14; the outer wall of the second sealing ring 29 can be closely arranged with the hole wall of the inlet hole 14, and the inner wall of the second sealing ring 29 can be closely arranged with the outer wall of the one-way valve 19; and the arrangement of the second sealing ring 29 can prevent the lubricating oil from flowing out of the inlet hole 14 to cause possible pollution.

The packing gland provided in Embodiment 1 still has the following problems in actual use: Since the packing filler 30 will continue to be worn out during the operation of the valve stem 6, this will cause the pressing force of the pressure ring 3 on the packing filler 30 to continue to decrease, thereby causing the packing filler 30 to become loose, resulting in problems with the sealing between the valve stem 6 and the valve body. To this end, based on Embodiment 1, Embodiment 2 is proposed.

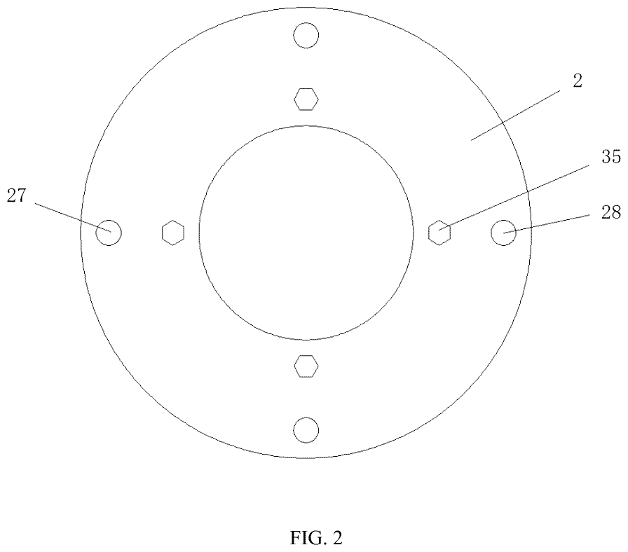

Embodiment 2: As shown in FIGS. 1 to 4, this embodiment provides a detachable and lubricable packing gland for an electric large caliber butterfly valve, including all the structures in Embodiment 1. Furthermore, an adjusting groove 31 arranged in a ring structure is further provided on the bottom of the gland body 2. The adjusting groove 31 is connected to communicate with the mounting groove 4, and the adjusting groove 31 is further coaxially arranged with the mounting groove 4. A second spring 32 is arranged in the adjusting groove 31, and an end of the second spring 32 close to the pressure ring 3 side is pressed against the pressure ring 3; and when the bottom wall of the pressure ring 3 is pressed against the packing, the second spring 32 is in a compressed state.

With the preceding setting, when the packing filler 30 is worn out, the volume of the packing filler 30 decreases, and the pressure generated by the packing filler 30 on the pressure ring 3 will decrease. At this moment, the second spring 32 can release its own elastic potential energy to move the pressure ring 3 in a direction close to the packing filler 30, so that the pressure ring 3 can keep pressing against the packing filler 30, so as to ensure that the packing filler 30 can remain compact even if the volume becomes smaller, thereby ensuring its sealing performance to ensure that the sealing between the valve stem 6 and the valve body is difficult to have problems.

In order to adjust the pressing force of the packing filler 30 to meet the needs of various working conditions, in this embodiment, an adjusting pressure plate 33 is further movably arranged in the adjusting groove 31. The bottom surface of the adjusting pressure plate 33 is connected to an end of the second spring 32 away from the pressure ring 3. Multiple adjusting threaded holes 34 are provided on the top of the gland body 2. In this embodiment, there are four adjusting threaded holes 34. The adjusting threaded holes 34 are distributed on the top of the gland body 2 in a circular array centered on the centerline of the gland body 2. Each adjusting threaded hole 34 is connected to communicate with the adjusting groove 31, each adjusting threaded hole 34 is threadedly connected with an adjusting screw 35, and the bottom of each adjusting screw 35 is rotatably connected to the adjusting pressure plate 33.

With the preceding setting, by rotating the adjusting screw 35, the adjusting screw 35 can make a corresponding movement into the adjusting threaded hole 34 or out of the adjusting threaded hole 34 through the threaded connection with the adjusting threaded hole 34. When the adjusting screw 35 moves into the adjusting threaded hole 34, it can push the adjusting pressure plate 33 to move downward in the adjusting groove 31, thereby squeezing the second spring 32 to make the pressure ring 3 move downward or have a tendency to move downward. In order to increase the pressing force of the pressure ring 3 on the packing filler 30, when the adjusting screw 35 moves out of the adjusting threaded hole 34, at this moment, the adjusting screw 35 can drive the adjusting pressure plate 33 to move upward, so that the pressure on the second spring 32 becomes smaller, and the pressing force of the pressure ring 3 on the packing filler 30 can be reduced, so as to adjust the pressing force of the packing filler 30.

In order to facilitate operators knowing the value of the pressing force of the pressure ring 3 on the packing filler 30, a pressure sensor 36 is further embedded in the bottom wall of the pressure ring 3, and the detection end of the pressure sensor 36 is tightly arranged against the packing filler 30. When the pressure ring 3 and the packing filler 30 are pressed together, the pressure sensor 36 will detect the corresponding pressure value. When the pressing force between the pressure ring 3 and the packing filler 30 changes, the pressure sensor 36 can further detect the corresponding pressure value change. The operator can know the specific pressing force value of the pressure ring 3 on the packing filler 30 by reading the value detected by the pressure sensor 36, so that the operator can make corresponding adjustments according to actual needs.

Since the pressure ring 3 can move when it is in the mounting hole 13, in order to ensure that the chip removal of oil filling can proceed smoothly, in this embodiment, an aperture of the oiling hole 10 is set larger than that of the inlet hole 14, and the aperture setting of the oiling hole 10 satisfies that when the pressure ring 3 moves in the mounting hole 13 under the action of the second spring 32 and the adjusting pressure plate 33, the oiling hole 10 can be connected to communicate with the inlet hole 14 at any time; and an aperture of the chip removal hole 11 is set larger than that of the outlet hole 15, and the aperture setting of the chip removal hole 11 satisfies that when the pressure ring 3 moves in the mounting hole 13 under the action of the second spring 32 and the adjusting pressure plate 33, the chip removal hole 11 can be connected to communicate with the outlet hole 15 at any time. With the preceding setting, even if the position of the pressure ring 3 is displaced to a certain extent, the oiling hole 10 can still be connected to communicate with the inlet hole 14, which is convenient for the entry of lubricating oil, and the chip removal hole 11 can still be connected to communicate with the outlet hole 15, which is convenient for the discharge of waste oil and rust.

The preceding embodiments are only embodiments of the present disclosure, and do not limit the patent scope of the present disclosure. Any equivalent structure or equivalent process transformations made by using the contents of the SPECIFICATION and the DRAWINGS OF SPECIFICATION of the present disclosure, or directly or indirectly applied in other related technical fields, are also included in the extent of the patent protection of the present disclosure.

What is claimed is:

1. A detachable and lubricable packing gland for an electric large caliber butterfly valve, comprising a packing gland body (1), wherein the packing gland body (1) comprises a gland body (2) and a pressure ring (3), the pressure ring (3) is arranged at the bottom of the gland body (2), a mounting groove (4) is opened on the bottom of the gland body (2), the diameter of the mounting groove (4) is larger than the outer diameter of the pressure ring (3), the top of the pressure ring (3) is arranged to extend into the mounting groove (4), and a first sealing ring (5) is arranged in a gap between the mounting groove (4) and an outer wall of the top of the pressure ring (3); a first through hole (7) for a valve stem (6) to pass through is provided on the gland body (2), and the first through hole (7) is connected to communicate with the mounting groove (4); a second through hole (8) for the valve stem (6) to pass through is provided on the pressure ring (3), and a lubrication groove (9) is provided on a hole wall of the second through hole (8); the lubrication groove (9) is provided at a middle position of the hole wall of the second through hole (8); an oiling hole (10) is provided on an outer wall of one side of the pressure ring (3), a chip removal hole (11) is provided on an outer wall of the other side, and both the oiling hole (10) and the chip removal hole (11) are connected to communicate with the lubrication groove (9).

2. The detachable and lubricable packing gland for an electric large caliber butterfly valve according to claim 1, wherein a mounting bracket (12) is further arranged below the gland body (2), the mounting bracket (12) is arranged in a T-shaped structure, a mounting hole (13) is provided on the mounting bracket (12), the gland body (2) is placed on the top surface of the mounting bracket (12), and the pressure ring (3) is arranged to extend into the mounting hole (13); an inlet hole (14) is provided on an outer wall of one side of the mounting bracket (12), and the inlet hole (14) is connected to communicate with the oiling hole (10); an outlet hole (15) is provided on an outer wall of the other side of the mounting bracket (12), and the outlet hole (15) is connected to communicate with the chip removal hole (11); and an adjusting assembly is further provided on the bottom wall of a top cross section structure of the mounting bracket (12) close to the inlet hole (14).

3. The detachable and lubricable packing gland for an electric large caliber butterfly valve according to claim 2, wherein the adjusting assembly comprises an adjusting box (16), and a fixing groove (17) is provided on the bottom wall of the top cross section structure of the mounting bracket (12); the adjusting box (16) is fixedly mounted in the fixing groove (17), the bottom of the adjusting box (16) extends outward from the fixing groove (17), and an oiling nozzle (18) and a one-way valve (19) are arranged on the box body where the adjusting box (16) extends out of the fixing groove (17); the oiling nozzle (18) is arranged on the side wall of the adjusting box (16) away from the inlet hole (14), the one-way valve (19) is arranged on the side wall of the adjusting box (16) close to the inlet hole (14), and the one-way valve (19) is arranged extending into the inlet hole (14); an adjusting cavity (20) is provided inside the adjusting box (16), connecting holes (21) are symmetrically arranged inside the adjusting cavity (20), and the connecting holes (21) on both sides are respectively connected to communicate with the oiling nozzle (18) and the one-way valve (19); a piston (22) is further movably provided inside the adjusting cavity (20), the piston (22) moves along the adjusting cavity (20) to control the conduction state of the connecting holes (21) on both sides, the piston (22) is connected to the top wall of the adjusting cavity (20) by providing a first spring (23), and a piston rod (24) is further provided on the piston (22).

4. The detachable and lubricable packing gland for an electric large caliber butterfly valve according to claim 3, wherein a first mounting threaded hole (25) and multiple first mounting bolt holes (26) are provided on the top cross section structure of the mounting bracket (12), among them, the first mounting threaded hole (25) is connected to communicate with the fixing groove (17), and an end of the piston rod (24) away from the piston (22) side is movably extended from the top of the adjusting box (16) into the first mounting threaded hole (25); a second mounting threaded hole (27) and multiple second mounting bolt holes (28) are provided on the gland body (2), the second mounting threaded hole (27) is arranged corresponding to the first mounting threaded hole (25), and the second mounting bolt holes (28) are arranged in a one-to-one correspondence with the first mounting bolt holes (26).

5. The detachable and lubricable packing gland for an electric large caliber butterfly valve according to claim 3, wherein a second sealing ring (29) is arranged in the inlet hole (14), and the one-way valve (19) is arranged to pass through the second sealing ring (29) after entering the inlet hole (14).

6. The detachable and lubricable packing gland for an electric large caliber butterfly valve according to claim 1, wherein the valve stem (6) passes through the gland body (2) and the pressure ring (3) in sequence and then enters the mounting hole (13), a packing filler (30) is filled between the hole wall of the mounting hole (13) and the outer wall of the valve stem (6), and the bottom wall of the pressure ring (3) is pressed against the packing filler (30).

7. The detachable and lubricable packing gland for an electric large caliber butterfly valve according to claim 6, wherein an adjusting groove (31) is further provided on the bottom of the gland body (2), the adjusting groove (31) is connected to communicate with the mounting groove (4), a second spring (32) is arranged in the adjusting groove (31), and an end of the second spring (32) close to the pressure ring (3) side is pressed against the pressure ring (3); and when the bottom wall of the pressure ring (3) is pressed against the packing, the second spring (32) is in a compressed state.

8. The detachable and lubricable packing gland for an electric large caliber butterfly valve according to claim 7, wherein an adjusting pressure plate (33) is further movably arranged in the adjusting groove (31), and the bottom surface of the adjusting pressure plate (33) is connected to an end of the second spring (32) away from the pressure ring (3); multiple adjusting threaded holes (34) are provided on the top of the gland body (2), each adjusting threaded hole (34) is connected to communicate with the adjusting groove (31), each adjusting threaded hole (34) is threadedly connected with an adjusting screw (35), and the bottom of each adjusting screw (35) is connected to the adjusting pressure plate (33).

9. The detachable and lubricable packing gland for an electric large caliber butterfly valve according to claim 8, wherein an aperture of the oiling hole (10) is set larger than that of the inlet hole (14), and the aperture setting of the oiling hole (10) satisfies that when the pressure ring (3) moves in the mounting hole (13) under the action of the second spring (32) and the adjusting pressure plate (33), the oiling hole (10) can be connected to communicate with the inlet hole (14) at any time; and an the aperture of the chip removal hole (11) is set larger than that of the outlet hole (15), and the aperture of the chip removal hole (11) satisfies that when the pressure ring (3) moves in the mounting hole (13) under the action of the second spring (32) and the adjusting pressure plate (33), the chip removal hole (11) can be connected to communicate with the outlet hole (15) at any time.

10. The detachable and lubricable packing gland for an electric large caliber butterfly valve according to claim 6, wherein a pressure sensor (36) is further embedded on the bottom wall of the pressure ring (3), and the detection end of the pressure sensor (36) is tightly arranged against the packing filler (30).
